(19) United States
(12) Patent Application Publication
(10) Pub. No.: US 2024/0227625 A1
(43) Pub. Date: Jul. 11, 2024

(54) START CONTROL DEVICE FOR FUEL CELL VEHICLE

(71) Applicants: Hino Motors, Ltd., Tokyo (JP); TOYOTA JIDOSHA KABUSHIKI KAISHA, Toyota-shi (JP)

(72) Inventors: Koichiro TANIGUCHI, Hino-shi (JP); Minoru KOWADA, Hino-shi (JP); Jun NAMIMA, Hino-shi (JP)

(73) Assignees: Hino Motors, Ltd., Tokyo (JP); TOYOTA JIDOSHA KABUSHIKI KAISHA, Toyota-shi (JP)

(21) Appl. No.: 18/408,687

(22) Filed: Jan. 10, 2024

(30) Foreign Application Priority Data
Jan. 11, 2023 (JP) 2023-002351

(51) Int. Cl. B60L 58/31; B60L 53/54

(52) U.S. Cl. CPC B60L 58/31; B60L 53/54

(57) ABSTRACT

A start control device for a fuel cell vehicle includes: a request determination unit configured to determine whether there is a request for starting the fuel cell vehicle in a second traveling mode after a power supply of the fuel cell vehicle is turned ON; and a start control unit configured to perform control to start the fuel cell vehicle in the second traveling mode when the request determination unit determines that there is a request for starting the fuel cell vehicle in the second traveling mode.

### TECHNICAL FIELD

The present disclosure relates to a start control device for a fuel cell vehicle.

### BACKGROUND

As a start control device for a fuel cell vehicle, for example, a technique described in Japanese Unexamined Patent Publication No. 2008-312418 is known. The start control device described in Japanese Unexamined Patent Publication No. 2008-312418 performs battery running in which the vehicle runs using stored power of a battery until starting of a fuel cell is ended after ignition (IG) of the fuel cell vehicle is turned ON, and performs fuel cell power generation running in which the vehicle runs using the generated power of the fuel cell and the stored power of the battery in combination when the starting of the fuel cell is ended.

### SUMMARY

In the conventional technique, when water (generated water) generated by power generation of the fuel cell is stored in a water storage tank of the fuel cell after the starting of the fuel cell is ended, the generated water is discharged from the water storage tank. Furthermore, even during the preparation for fuel cell power generation until the starting of the fuel cell is ended, fuel and air are supplied to a fuel cell stack to generate power, and thus generated water may be discharged from the water storage tank. By the way, the fuel cell vehicle may be parked in a place where drainage is not allowed, such as a factory site or a multi-story parking lot. Furthermore, when the fuel cell is started, operating noise of the fuel cell is generated, but the fuel cell vehicle may be parked in a place where noise is not allowed. For this reason, depending on a place where the fuel cell vehicle is parked, it is desired to suppress drainage from the fuel cell and generation of operating noise at the time of starting the fuel cell vehicle.

An object of the present disclosure is to provide a start control device for a fuel cell vehicle capable of suppressing drainage from a fuel cell and generation of an operating noise at the time of starting the fuel cell vehicle.

(1) One aspect of the present disclosure is a start control device for a fuel cell vehicle capable of switching between a first traveling mode in which the vehicle travels mainly using power generated by a fuel cell and a second traveling mode in which the vehicle travels using discharge power of a battery, the start control device including: a request determination unit configured to determine whether there is a request for starting the fuel cell vehicle in the second traveling mode after a power supply of the fuel cell vehicle is turned ON; and a start control unit configured to perform control to start the fuel cell vehicle in the second traveling mode when the request determination unit determines that there is a request for starting the fuel cell vehicle in the second traveling mode.

In such a start control device, after the power supply of the fuel cell vehicle is turned ON, it is determined whether there is a request for starting the fuel cell vehicle in the second traveling mode in which the vehicle travels using the discharge power of the battery. When it is determined that there is a request for starting the fuel cell vehicle in the second traveling mode, the fuel cell vehicle is controlled to start in the second traveling mode. Therefore, when there is a request for starting the fuel cell vehicle in the second traveling mode, the fuel cell is not started, and power generation of the fuel cell is not performed. Therefore, since water is not generated in the fuel cell, it is not necessary to discharge generated water from the fuel cell. Furthermore, since the fuel cell does not start, no operating noise is generated from the fuel cell. Accordingly, at the time of starting the fuel cell vehicle, it is possible to suppress drainage from the fuel cell and generation of operating noise.

(2) In the above-described (1), the fuel cell vehicle may include a manual operation unit configured to perform an instruction operation for draining generated water stored in the fuel cell, and the request determination unit may be configured to determine whether an instruction operation for draining the generated water has been performed by the manual operation unit immediately before the power supply of the fuel cell vehicle was turned OFF last time, and to determine that there is a request for starting the fuel cell vehicle in the second traveling mode when the instruction operation for draining the generated water has been performed immediately before the power supply was turned OFF last time.

When the instruction operation for draining the generated water stored in the fuel cell has been performed by the manual operation unit immediately before the power supply of the fuel cell vehicle was turned OFF last time, the generated water stored in the fuel cell may be drained when the power supply of the fuel cell vehicle is turned ON and the fuel cell is started. Therefore, when the instruction operation for draining the generated water has been performed immediately before the power supply was turned OFF last time, it is determined that there is a request for starting the fuel cell vehicle in the second traveling mode, whereby the fuel cell vehicle is automatically started in the second traveling mode.

(3) In the above-described (1), the request determination unit may configured to determine whether a traveling mode of the fuel cell vehicle has been switched to the second traveling mode immediately before the power supply of the fuel cell vehicle was turned OFF last time, and to determine that there is a request for starting the fuel cell vehicle in the second traveling mode when the traveling mode of the fuel cell vehicle has been switched to the second traveling mode immediately before the power supply was turned OFF last time.

When the traveling mode of the fuel cell vehicle has been switched to the second traveling mode immediately before the power supply of the fuel cell vehicle was turned OFF last time, there is a possibility that the fuel cell vehicle is present in a place where drainage is not allowed or a place where noise is not allowed. Therefore, when the traveling mode of the fuel cell vehicle has been switched to the second traveling mode immediately before the power supply was turned OFF last time, it is determined that there is a request for starting the fuel cell vehicle in the second traveling mode, whereby the fuel cell vehicle is automatically started in the second traveling mode.

(4) In the above-described (1), the fuel cell vehicle may include a manual operation unit configured to perform an instruction operation for causing the fuel cell vehicle to travel in the second traveling mode, and the request determination unit may be configured to determine whether an instruction operation for causing the fuel cell vehicle to travel in the second traveling mode has been performed by the manual operation unit, and to determine that there is a request for starting the fuel cell vehicle in the second traveling mode when the instruction operation for causing the fuel cell vehicle to travel in the second traveling mode has been performed.

When the instruction operation for causing the fuel cell vehicle to travel in the second traveling mode has been performed by the manual operation unit after the power supply of the fuel cell vehicle is turned ON, it is considered that a driver of the fuel cell vehicle intends to start the fuel cell vehicle in the second traveling mode. Therefore, when the instruction operation for causing the fuel cell vehicle to travel in the second traveling mode has been performed by the manual operation unit, it is determined that there is a request for starting the fuel cell vehicle in the second traveling mode, whereby the fuel cell vehicle is started in the second traveling mode by the will of the driver.

(5) In the above-described (1), the fuel cell vehicle may include a car navigation system configured to assist traveling of the fuel cell vehicle, and the request determination unit may be configured to determine whether the fuel cell vehicle is present at a designated place registered in advance in the car navigation system based on information of the car navigation system, and to determine that there is a request for starting the fuel cell vehicle in the second traveling mode when the fuel cell vehicle is present at the designated place.

When the designated place is registered in advance in the car navigation system, it is considered that the driver of the fuel cell vehicle recognizes a place where the driver does not want to start the fuel cell. Therefore, when the fuel cell vehicle is present at the designated place registered in advance in the car navigation system, it is determined that there is a request for starting the fuel cell vehicle in the second traveling mode, whereby the fuel cell vehicle is automatically started in the second traveling mode.

(6) In any one of the above-described (1) to (5), the start control device may further include a charging rate detection unit configured to detect a charging rate of the battery, and the start control unit may be configured to perform control to start the fuel cell vehicle in the second traveling mode when the request determination unit determines that there is a request for starting the fuel cell vehicle in the second traveling mode and the charging rate of the battery detected by the charging rate detection unit is greater than or equal to a predetermined threshold.

With such a configuration, it is possible to suppress shortage of stored power of the battery when the fuel cell vehicle travels as it is in the second traveling mode after the fuel cell vehicle is started in the second traveling mode.

According to the present disclosure, at the time of starting a fuel cell vehicle, it is possible to suppress drainage from a fuel cell and generation of operating noise.

### BRIEF DESCRIPTION OF THE DRAWINGS

FIG. 1 is a schematic configuration diagram showing a main part of a fuel cell vehicle including a start control device according to an embodiment of the present disclosure;

FIG. 2 is a block diagram of a vehicle control device including the start control device shown in FIG. 1;

FIG. 3 is a flowchart showing a procedure of a request determination process executed by an EV traveling mode request determination unit shown in FIG. 2; and

FIG. 4 is a flowchart showing a procedure of a permission determination process executed by the EV traveling mode permission determination unit illustrated in FIG. 2.

### DETAILED DESCRIPTION

Hereinafter, embodiments of the present disclosure will be described with reference to the drawings.

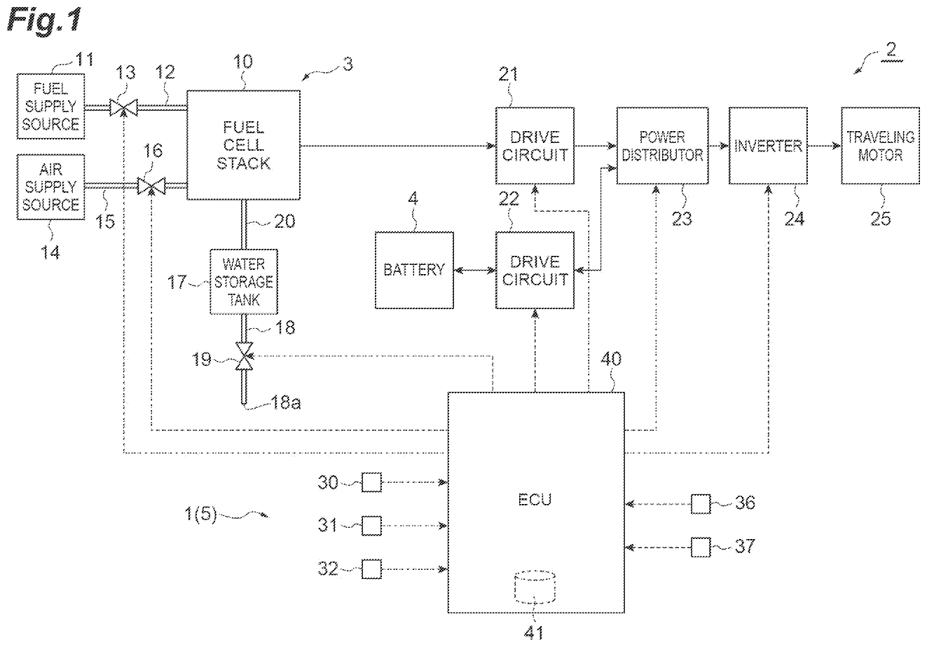

FIG. 1 is a schematic configuration diagram showing a main part of a fuel cell vehicle including a start control device according to an embodiment of the present disclosure. In FIG. 1, a start control device 1 of the present embodiment is a device that performs start control of a fuel cell vehicle 2. The start control device 1 is included in a vehicle control device 5. The vehicle control device 5 is mounted on the fuel cell vehicle 2. The fuel cell vehicle 2 is a large commercial vehicle such as a large truck.

The fuel cell vehicle 2 includes a fuel cell 3 that generates power and a battery 4 that can be charged and discharged. The fuel cell vehicle 2 is a power train that drives the fuel cell 3 and the battery 4 as a power source. The fuel cell vehicle 2 can switch between a normal traveling mode and an EV traveling mode.

The normal traveling mode is a first traveling mode in which the vehicle travels mainly using power generated by the fuel cell 3. Specifically, the normal traveling mode is a traveling mode in which the vehicle travels using the power generated by the fuel cell 3 and discharge power of the battery 4. The generated power of the fuel cell 3 is power generated by the fuel cell 3. The discharge power of the battery 4 is power stored in the battery 4.

The EV traveling mode is a second traveling mode in which the vehicle travels using the discharge power of the battery 4. Specifically, the EV traveling mode is a traveling mode in which the vehicle travels using only the discharge power of the battery 4 without using the power generated by the fuel cell 3.

The fuel cell 3 includes a fuel cell stack 10, a fuel supply source 11, a fuel supply pipe 12, a fuel flow control valve 13, an air supply source 14, an air supply pipe 15, an air flow control valve 16, a water storage tank 17, a drain pipe 18, and a drain valve 19.

The fuel cell stack 10 generates electric power by chemically reacting fuel (here, hydrogen) with oxygen in air. The fuel cell stack 10 has a structure in which a plurality of unit cells is stacked. In the fuel cell stack 10, since hydrogen and oxygen chemically react with each other, water is generated.

The fuel supply source 11 supplies fuel to the fuel cell stack 10. The fuel supply pipe 12 is a pipe that connects the fuel supply source 11 and the fuel cell stack 10 and through which fuel flows from the fuel supply source 11 to the fuel cell stack 10. The fuel flow control valve 13 is an electromagnetic flow control valve that is disposed in the fuel supply pipe 12 and controls a flow rate of fuel supplied to the fuel cell stack 10.

The air supply source 14 supplies air to the fuel cell stack 10. The air supply pipe 15 is a pipe that connects the air supply source 14 and the fuel cell stack 10 and through which air flows from the air supply source 14 to the fuel cell stack 10. The air flow control valve 16 is an electromagnetic flow control valve that is disposed in the air supply pipe 15 and controls a flow rate of air supplied to the fuel cell stack 10.

The water storage tank 17 is connected to an anode of the fuel cell stack 10 through a pipe 20. The water storage tank 17 is a tank that stores water (generated water) generated by the fuel cell stack 10. The drain pipe 18 is a pipe that is connected to the water storage tank 17 and discharges the generated water stored in the water storage tank 17.

The drain valve 19 is an electromagnetic on-off valve that is disposed in the drain pipe 18 and opens and closes a discharge flow path for the generated water. When the drain valve 19 is opened, the generated water stored in the water storage tank 17 flows through the drain pipe 18 and is discharged from a discharge port 18a provided at a distal end of the drain pipe 18.

Note that the generated water may be stored in the fuel cell stack 10 to be in a water storage state. In this case, a part of the generated water permeates the anode of the fuel cell stack 10. The anode stores the generated water in a gas-liquid separator, and discharges the generated water when the stored water amount becomes more than or equal to a certain amount.

As the battery 4, for example, a lithium ion secondary battery or the like is used. When the power generated by the fuel cell 3 is supplied to the battery 4, the battery 4 is charged.

Furthermore, the fuel cell vehicle 2 includes a drive circuit 21, a drive circuit 22, a power distributor 23, an inverter 24, and a traveling motor 25.

The drive circuit 21 includes a switching circuit (not illustrated) that opens and closes the fuel cell stack 10 and the power distributor 23. The drive circuit 22 includes a switching circuit (not illustrated) that opens and closes the battery 4 and the power distributor 23.

The power distributor 23 distributes the generated power of the fuel cell 3 and discharge power of the battery 4. Specifically, the power distributor 23 supplies the generated power of the fuel cell 3 and the discharge power of the battery 4 to the inverter 24. Furthermore, the power distributor 23 supplies the generated power of the fuel cell 3 to the battery 4 to charge the battery 4.

The inverter 24 converts DC power from the fuel cell 3 and the battery 4 into AC power and supplies the AC power to the traveling motor 25.

The traveling motor 25 rotationally drives a drive wheel (not illustrated) of the fuel cell vehicle 2. As the traveling motor 25, for example, a three-phase AC synchronous motor is used.

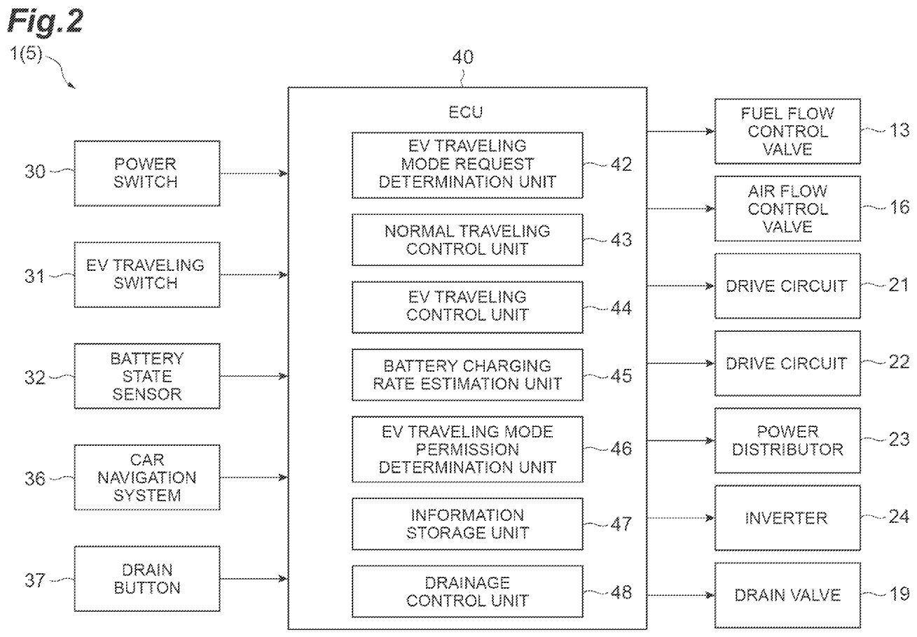

As also shown in FIG. 2, the vehicle control device 5 includes a power switch 30, an EV traveling switch 31, a battery state sensor 32, a car navigation system 36, a drain button 37, and an electronic control unit (ECU) 40.

The power switch 30 is disposed in a driver's seat (not illustrated) of the fuel cell vehicle 2. The power switch 30 starts (initiates) the fuel cell vehicle 2. The power switch 30 is a switch for turning ON/OFF a power supply of the fuel cell vehicle 2. When the power switch 30 is turned ON, the power supply of the fuel cell vehicle 2 is turned ON, and the stored power of the battery 4 is supplied to each electric system of the fuel cell vehicle 2.

The EV traveling switch 31 is disposed in the driver's seat (not illustrated) of the fuel cell vehicle 2. The EV traveling switch 31 is a manual operation switch (manual operation unit) by which a driver of the fuel cell vehicle 2 performs an instruction operation for causing the fuel cell vehicle 2 to travel in the EV traveling mode.

The battery state sensor 32 is a sensor that detects a state of the battery 4. The battery state sensor 32 includes a voltmeter that measures a voltage of the battery 4, a wattmeter that measures output power of the battery 4, a thermometer that measures a temperature of the battery 4, and the like.

The car navigation system 36 is disposed in the driver's seat (not illustrated) of the fuel cell vehicle 2. The car navigation system 36 is a device that assists the traveling of the fuel cell vehicle 2, such as displaying the current position of the fuel cell vehicle 2 and guiding a route of the fuel cell vehicle 2 to the destination.

The drain button 37 is disposed in the driver's seat (not shown) of the fuel cell vehicle 2. The drain button 37 is a manual operation button (manual operation unit) for the driver to perform an instruction operation for draining generated water stored in the fuel cell 3.

The ECU 40 includes, for example, a CPU, a ROM, a RAM, an input/output interface, and the like. The ECU 40 incorporates a storage unit 41.

As shown in FIG. 2, the ECU 40 includes an EV traveling mode request determination unit 42, a normal traveling control unit 43, an EV traveling control unit 44, a battery charging rate estimation unit 45, an EV traveling mode permission determination unit 46, an information storage unit 47, and a drainage control unit 48.

Immediately after the power switch 30 of the fuel cell vehicle 2 is turned ON, the EV traveling mode request determination unit 42 determines whether there is a request for starting the fuel cell vehicle 2 in the EV traveling mode based on information stored in the storage unit 41, an operation signal of the EV traveling switch 31, and registration information of the car navigation system 36. In cooperation with the storage unit 41, the EV traveling mode request determination unit 42 constitutes a request determination unit that determines whether there is a request for starting the fuel cell vehicle 2 in the EV traveling mode after the power supply of the fuel cell vehicle 2 is turned ON.

The normal traveling control unit 43 controls the fuel flow control valve 13, the air flow control valve 16, the drive circuits 21 and 22, and the power distributor 23 so that the fuel cell vehicle 2 travels in the normal traveling mode.

Specifically, the normal traveling control unit 43 controls the opening degrees of the fuel flow control valve 13 and the air flow control valve 16 to generate power of the fuel cell 3, and controls the drive circuits 21 and 22 and the power distributor 23 so that the generated power of the fuel cell 3 and the discharge power of the battery 4 are supplied to the inverter 24. Furthermore, the normal traveling control unit 43 controls the drive circuits 21 and 22 and the power distributor 23 such that the generated power of the fuel cell 3 is supplied to the battery 4 as necessary.

The EV traveling control unit 44 controls the fuel flow control valve 13, the air flow control valve 16, the drive circuits 21 and 22, and the power distributor 23 so that the fuel cell vehicle 2 travels in the EV traveling mode.

Specifically, the EV traveling control unit 44 controls the fuel flow control valve 13 and the air flow control valve 16 to be in a fully closed state to stop the power generation of the fuel cell 3 and controls the drive circuits 21 and 22 and the power distributor 23 so that the discharge power of the battery 4 is supplied to the inverter 24.

The battery charging rate estimation unit 45 estimates a state of charge (SOC) of the battery 4 on the basis of a state of the battery 4 detected by the battery state sensor 32. For example, the battery charging rate estimation unit 45 calculates an open voltage of the battery 4 from a measurement value of the voltmeter, and obtains a charging rate of the battery 4 from the open voltage of the battery 4. Note that the battery 4 has a characteristic that the charging rate increases as the open voltage increases. The battery charging rate estimation unit 45 constitutes a charging rate detection unit that detects a charging rate of the battery 4 in cooperation with the battery state sensor 32.

The EV traveling mode permission determination unit 46 determines whether to permit traveling in the EV traveling mode based on a determination result by the EV traveling mode request determination unit 42 and an estimation result by the battery charging rate estimation unit 45.

In cooperation with the EV traveling control unit 44, the EV traveling mode permission determination unit 46 constitutes a start control unit that performs control to start the fuel cell vehicle 2 in the EV traveling mode when the EV traveling mode request determination unit 42 determines that there is a request for starting the fuel cell vehicle 2 in the EV traveling mode.

The information storage unit 47 stores various kinds of information of the fuel cell vehicle 2 in the storage unit 41. Specifically, the information storage unit 47 stores, in the storage unit 41, an operation signal of the drain button 37 and information such as a traveling mode of the fuel cell vehicle 2 immediately before the power switch 30 of the fuel cell vehicle 2 is turned OFF.

The drainage control unit 48 performs control to open the drain valve 19 when the drain button 37 is turned ON. Then, since the drain valve 19 is opened, the generated water stored in the fuel cell 3 is drained.

In the above description, the storage unit 41, the EV traveling mode request determination unit 42, the normal traveling control unit 43, the EV traveling control unit 44, the battery charging rate estimation unit 45, and the EV traveling mode permission determination unit 46 constitute the start control device 1 of the present embodiment.

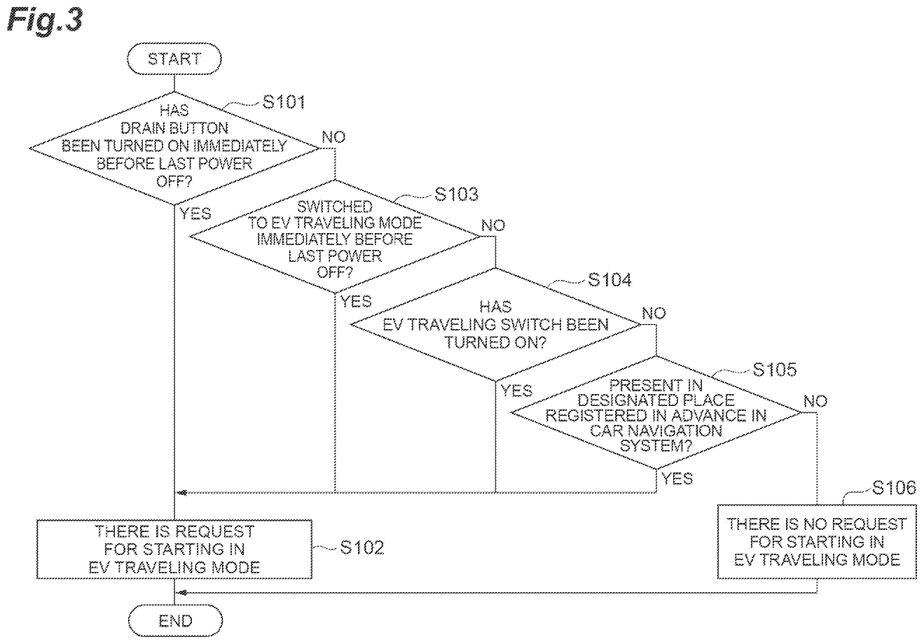

FIG. 3 is a flowchart showing a procedure of a request determination process executed by the EV traveling mode request determination unit 42. This process is executed when the power switch 30 is turned ON from the OFF state.

In FIG. 3, the EV traveling mode request determination unit 42 first determines whether the drain button 37 has been turned ON immediately before the power switch 30 was turned OFF last time based on the information stored in the storage unit 41 (step S101).

When determining that the drain button 37 has been turned ON immediately before the power switch 30 was turned OFF last time, the EV traveling mode request determination unit 42 determines that there is a request for starting the fuel cell vehicle 2 in the EV traveling mode (step S102).

When determining that the drain button 37 is not turned ON immediately before the power switch 30 was turned OFF last time, the EV traveling mode request determination unit 42 determines whether the traveling mode of the fuel cell vehicle 2 has been switched from the normal traveling mode to the EV traveling mode immediately before the power switch 30 was turned OFF last time based on the information stored in the storage unit 41 (step S103).

When determining that the traveling mode of the fuel cell vehicle 2 has been switched to the EV traveling mode immediately before the power switch 30 was turned OFF last time, the EV traveling mode request determination unit 42 determines that there is a request for starting the fuel cell vehicle 2 in the EV traveling mode (step S102).

When determining that the traveling mode of the fuel cell vehicle 2 has not been switched to the EV traveling mode immediately before the power switch 30 was turned OFF last time, the EV traveling mode request determination unit 42 determines whether the EV traveling switch 31 has been turned ON based on the operation signal of the EV traveling switch 31 (step S104).

When determining that the EV traveling switch 31 has been turned ON, the EV traveling mode request determination unit 42 determines that there is a request for starting the fuel cell vehicle 2 in the EV traveling mode (step S102).

When determining that the EV traveling switch 31 is not turned ON, the EV traveling mode request determination unit 42 determines whether the fuel cell vehicle 2 is present in the designated place registered in advance in the car navigation system 36 based on the registration information of the car navigation system 36 (step S105). The designated place is a place where drainage and noise are not allowed, such as a factory site, a home parking lot, or a multi-story parking lot. That is, the designated place is a place where the fuel cell 3 is not desired to be started because drainage and noise are not allowed.

When determining that the fuel cell vehicle 2 is present in the designated place registered in advance in the car navigation system 36, the EV traveling mode request determination unit 42 determines that there is a request for starting the fuel cell vehicle 2 in the EV traveling mode (step S102).

When determining that the fuel cell vehicle 2 is not present in the designated place registered in advance in the car navigation system 36, the EV traveling mode request determination unit 42 determines that there is no request for starting the fuel cell vehicle 2 in the EV traveling mode (step S106).

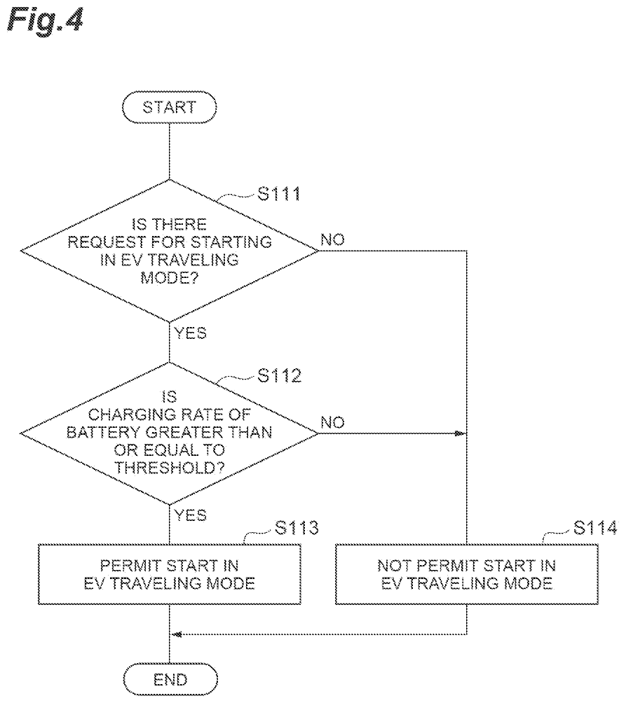

FIG. 4 is a flowchart showing a procedure of a permission determination process executed by the EV traveling mode permission determination unit 46. This process is also executed when the power switch 30 is turned ON from the OFF state.

In FIG. 4, the EV traveling mode permission determination unit 46 first determines whether there is a request for starting the fuel cell vehicle 2 in the EV traveling mode from the determination result by the EV traveling mode request determination unit 42 (step S111).

When determining that there is a request for starting the fuel cell vehicle 2 in the EV traveling mode, the EV traveling mode permission determination unit 46 determines whether the charging rate of the battery 4 estimated by the battery charging rate estimation unit 45 is greater than or equal to a predetermined threshold (A %) (step S112). The threshold is, for example, an upper limit value of the charging rate of the battery 4. The upper limit value of the charging rate of the battery 4 is a value close to full charge of the battery 4 (for example, 85% to 95%).

When determining that the charging rate of the battery 4 is greater than or equal to the threshold, the EV traveling mode permission determination unit 46 permits the start in the EV traveling mode (step S113). When the start in the EV traveling mode is permitted, the EV traveling control unit 44 controls the fuel cell vehicle 2 to start in the EV traveling mode.

When determining in step S111 that there is no request for starting the fuel cell vehicle 2 in the EV traveling mode or when determining in step S112 that the charging rate of the battery 4 is not greater than or equal to the threshold, the EV traveling mode permission determination unit 46 does not permit the start in the EV traveling mode (step S114). When the start in the EV traveling mode is not permitted, the normal traveling control unit 43 controls the fuel cell vehicle 2 to start in the normal traveling mode.

As described above, in the present embodiment, after the power switch 30 of the fuel cell vehicle 2 is turned ON, it is determined whether there is a request for starting the fuel cell vehicle 2 in the EV traveling mode in which the vehicle travels using the discharge power of the battery 4. Then, when it is determined that there is a request for starting the fuel cell vehicle 2 in the EV traveling mode, the fuel cell vehicle 2 is controlled to start in the EV traveling mode. Thus, when there is a request for starting the fuel cell vehicle 2 in the EV traveling mode, the fuel cell 3 is not started, and the power generation of the fuel cell 3 is not performed. Therefore, since water is not generated in the fuel cell 3, generated water does not need to be discharged from the fuel cell 3. Furthermore, since the fuel cell 3 is not started, no operating noise is generated from the fuel cell 3. As a result, regardless of a parking place of the fuel cell vehicle 2, at the time of starting the fuel cell vehicle 2, it is possible to suppress drainage from the fuel cell 3 and generation of operating noise.

Furthermore, in the present embodiment, it is determined whether an instruction operation for draining the generated water by the drain button 37 has been performed immediately before the power switch 30 of the fuel cell vehicle 2 was turned OFF last time, and when the instruction operation for draining the generated water has been performed immediately before the power switch 30 was turned OFF last time, it is determined that there is a request for starting the fuel cell vehicle 2 in the EV traveling mode. When the instruction operation for draining the generated water stored in the fuel cell 3 has been performed by the drain button 37 immediately before the power switch 30 of the fuel cell vehicle 2 was turned OFF last time, the generated water stored in the fuel cell 3 may be drained when the power switch 30 of the fuel cell vehicle 2 is turned ON to start the fuel cell 3, Therefore, when the instruction operation for draining the generated water has been performed immediately before the power switch 30 was turned OFF last time, it is determined that there is a request for starting the fuel cell vehicle 2 in the EV traveling mode, whereby the fuel cell vehicle 2 is automatically started in the EV traveling mode.

Furthermore, in the present embodiment, it is determined whether the traveling mode of the fuel cell vehicle 2 has been switched to the EV second traveling mode immediately before the power switch 30 of the fuel cell vehicle 2 was turned OFF last time, and when the traveling mode of the fuel cell vehicle 2 has been switched to the EV traveling mode immediately before the power switch 30 was turned OFF last time, it is determined that there is a request for starting the fuel cell vehicle 2 in the EV traveling mode. When the traveling mode of the fuel cell vehicle 2 has been switched to the EV traveling mode immediately before the power switch 30 of the fuel cell vehicle 2 was turned OFF last time, there is a possibility that the fuel cell vehicle 2 is present in a place where drainage is not allowed or a place where noise is not allowed. Therefore, when the traveling mode of the fuel cell vehicle 2 has been switched to the EV traveling mode immediately before the power switch 30 was turned OFF last time, it is determined that there is a request for starting the fuel cell vehicle 2 in the EV traveling mode, whereby the fuel cell vehicle 2 is automatically started in the EV traveling mode.

Furthermore, in the present embodiment, the EV traveling switch 31 determines whether an instruction operation for causing the fuel cell vehicle 2 to travel in the EV traveling mode has been performed, and when the instruction operation for causing the fuel cell vehicle 2 to travel in the EV traveling mode has been performed, it is determined that there is a request for starting the fuel cell vehicle 2 in the EV traveling mode. When the instruction operation for causing the fuel cell vehicle 2 to travel in the EV traveling mode has been performed by the EV traveling switch 31 after the power switch 30 of the fuel cell vehicle 2 is turned ON, it is considered that the driver of the fuel cell vehicle 2 intends to start the fuel cell vehicle 2 in the EV traveling mode. Therefore, when the instruction operation for causing the fuel cell vehicle 2 to travel in the EV traveling mode has been performed by the EV traveling switch 31, it is determined that there is a request for starting the fuel cell vehicle 2 in the EV traveling mode, whereby the fuel cell vehicle 2 is started in the EV traveling mode by the will of the driver.

Furthermore, in the present embodiment, it is determined whether the fuel cell vehicle 2 is present at the designated place registered in advance in the car navigation system 36 on the basis of the information of the car navigation system 36, and when the fuel cell vehicle 2 is present at the designated place, it is determined that there is a request for starting the fuel cell vehicle 2 in the EV traveling mode. When the designated place is registered in advance in the car navigation system 36, it is considered that the driver of the fuel cell vehicle 2 recognizes a place where the driver does not want to start the fuel cell 3. Therefore, when the fuel cell vehicle 2 is present at the designated place registered in advance in the car navigation system 36, it is determined that there is a request for starting the fuel cell vehicle 2 in the EV traveling mode, whereby the fuel cell vehicle 2 is automatically started in the EV traveling mode.

Furthermore, in the present embodiment, when it is determined that there is a request for starting the fuel cell vehicle 2 in the EV traveling mode, and the charging rate of the battery 4 is greater than or equal to a predetermined threshold, the fuel cell vehicle 2 is controlled to start in the EV traveling mode. Therefore, when the fuel cell vehicle 2 travels as it is in the EV traveling mode after the fuel cell vehicle 2 is started in the EV traveling mode, the stored power of the battery 4 can be suppressed from becoming insufficient.

Note that the present disclosure is not limited to the above embodiments. For example, in the above embodiment, when it is determined that there is a request for starting the fuel cell vehicle 2 in the EV traveling mode, the fuel cell vehicle 2 is controlled to be started in the EV traveling mode, and when it is determined that there is no request for starting the fuel cell vehicle 2 in the EV traveling mode, the fuel cell vehicle 2 is controlled to be started in the normal traveling mode. However, the present disclosure is not particularly limited to such a mode. For example, even when it is determined that there is no request for starting the fuel cell vehicle 2 in the EV traveling mode, when the charging rate of the battery 4 is greater than or equal to the threshold, the fuel cell vehicle 2 may be controlled to be started in the EV traveling mode.

Furthermore, in the above embodiment, the fuel flow control valve 13 and the air flow control valve 16 are fully closed to stop the supply of the fuel and the air to the fuel cell stack 10, so that the power generation of the fuel cell 3 is stopped. However, the present disclosure is not particularly limited to this mode. For example, a power supply (not illustrated) of the fuel cell 3 may be turned off to stop the operation of the fuel cell 3, so that the power generation of the fuel cell 3 is stopped.

Furthermore, in the above embodiment, hydrogen is used as the fuel, but the fuel to be used is not particularly limited to hydrogen, and may be natural gas, methanol, or the like. In this case, a reformer that reforms the fuel to generate hydrogen is required.

Furthermore, in the above embodiment, the fuel cell vehicle 2 is a large commercial vehicle, but the fuel cell vehicle 2 is not particularly limited to a large commercial vehicle, and may be a small commercial vehicle, a passenger car, or the like.

In this case, when the fuel cell vehicle 2 travels in the normal traveling mode, a driving mode of the fuel cell vehicle 2 may be changed according to the load of the fuel cell vehicle 2. For example, the fuel cell vehicle 2 may be driven by using only the discharge power of the battery 4 while stopping the power generation of the fuel cell 3 at the time of the light load, and the fuel cell vehicle 2 may be driven by using the generated power of the fuel cell 3 and the discharge power of the battery 4 at the time of the high load.

### REFERENCE SIGNS LIST

1 start control device
2 fuel cell vehicle
3 fuel cell
4 battery
30 power switch (power supply)
31 EV traveling switch (manual operation unit)
32 battery state sensor (charging rate detection unit)
36 car navigation system
37 drain button (manual operation unit)
41 storage unit (request determination unit)
42 EV traveling mode request determination unit (request determination unit)
44 EV traveling control unit (start control unit)
45 battery charging rate estimation unit (charging rate detection unit)
46 EV traveling mode permission determination unit (start control unit).

What is claimed is:

1. A start control device for a fuel cell vehicle capable of switching between a first traveling mode in which the vehicle travels mainly using power generated by a fuel cell and a second traveling mode in which the vehicle travels using discharge power of a battery, the start control device comprising:
a request determination unit configured to determine whether there is a request for starting the fuel cell vehicle in the second traveling mode after a power supply of the fuel cell vehicle is turned ON; and
a start control unit configured to perform control to start the fuel cell vehicle in the second traveling mode when the request determination unit determines that there is a request for starting the fuel cell vehicle in the second traveling mode.

2. The start control device for a fuel cell vehicle according to claim 1, wherein
the fuel cell vehicle includes a manual operation unit configured to perform an instruction operation for draining generated water stored in the fuel cell, and
the request determination unit is configured to determine whether an instruction operation for draining the generated water has been performed by the manual operation unit immediately before the power supply of the fuel cell vehicle was turned OFF last time, and to determine that there is a request for starting the fuel cell vehicle in the second traveling mode when the instruction operation for draining the generated water has been performed immediately before the power supply was turned OFF last time.

3. The start control device for a fuel cell vehicle according to claim 1, wherein
the request determination unit is configured to determine whether a traveling mode of the fuel cell vehicle has been switched to the second traveling mode immediately before the power supply of the fuel cell vehicle was turned OFF last time, and to determine that there is a request for starting the fuel cell vehicle in the second traveling mode when the traveling mode of the fuel cell vehicle has been switched to the second traveling mode immediately before the power supply was turned OFF last time.

4. The start control device for a fuel cell vehicle according to claim 1, wherein
the fuel cell vehicle includes a manual operation unit configured to perform an instruction operation for causing the fuel cell vehicle to travel in the second traveling mode, and
the request determination unit is configured to determine whether an instruction operation for causing the fuel cell vehicle to travel in the second traveling mode has been performed by the manual operation unit, and to determine that there is a request for starting the fuel cell vehicle in the second traveling mode when the instruction operation for causing the fuel cell vehicle to travel in the second traveling mode has been performed.

5. The start control device for a fuel cell vehicle according to claim 1, wherein
the fuel cell vehicle includes a car navigation system configured to assist traveling of the fuel cell vehicle, and
the request determination unit is configured to determine whether the fuel cell vehicle is present at a designated place registered in advance in the car navigation system based on information of the car navigation system, and to determine that there is a request for starting the fuel cell vehicle in the second traveling mode when the fuel cell vehicle is present at the designated place.

6. The start control device for a fuel cell vehicle according to claim 1, further comprising
a charging rate detection unit configured to detect a charging rate of the battery, wherein
the start control unit is configured to perform control to start the fuel cell vehicle in the second traveling mode when the request determination unit determines that there is a request for starting the fuel cell vehicle in the second traveling mode and the charging rate of the battery detected by the charging rate detection unit is greater than or equal to a predetermined threshold.
